(19) United States
(12) Patent Application Publication
(10) Pub. No.: US 2017/0262678 A1
(43) Pub. Date: Sep. 14, 2017

(54) WIRELESS BARCODE SCANNING APPARATUS AND WIRELESS BARCODE SCANNING SYSTEM INCLUDING THE SAME

(71) Applicant: SINBON ELECTRONICS COMPANY LTD., New Taipei City (TW)

(72) Inventors: YU-CHUAN LIN, New Taipei City (TW); Yi-Ju WU, New Taipei City (TW)

(73) Assignee: SINBON ELECTRONICS COMPANY LTD., New Taipei City (TW)

(21) Appl. No.: 15/170,060

(22) Filed: Jun. 1, 2016

(30) Foreign Application Priority Data
Mar. 8, 2016 (TW) 105203163

(51) Int. Cl. G06K 7/10; H02J 7/00; H04W 4/00

(52) U.S. Cl. CPC G06K 7/10891; G06K 7/10861; H04W 4/008; G06K 7/10396; H02J 7/0052; H02J 2007/0062

(57) ABSTRACT

A wireless barcode scanning system includes a wireless barcode scanning apparatus and an electronic apparatus, and a Bluetooth connection is established between the wireless barcode scanning apparatus and the electronic apparatus. The wireless barcode scanning apparatus reads a barcode to acquire barcode information of the barcode and the barcode information is transmitted to the electronic apparatus to be stored and/or displayed by the Bluetooth connection. Therefore, the wireless barcode scanning apparatus may be widely applied to the wireless transmission of scanned barcode data because of quick-speed induction and connection and high-volume data transmission.

### BACKGROUND

### 1. Technical Field

The present disclosure relates generally to a barcode scanning apparatus and barcode scanning system, and more particularly to a wireless barcode scanning apparatus with an integrated Bluetooth and near field communication technology and a wireless barcode scanning system including the same.

### 2. Description of Related Art

FIG. 6 shows a schematic view of using a conventional wired barcode scanner. In general, a wired barcode scanner 400 is handheld by a user to approach close to a barcode 500 to acquire barcode information of the barcode 500. The acquired barcode information is stored in the wired barcode scanner 400.

However, it is inconvenient to operate the wired barcode scanner 400 due to the limitation of the length of a power wire connected to the wired barcode scanner 400. Also, the scope of using the wired barcode scanner 400 is limited. In addition, the wired barcode scanner 400 is only matched with a single or a few products because of the requirement of compatibility. Furthermore, it is complicated to access and use the barcode information stored in the wired barcode scanner 400.

### SUMMARY

An objective of the present disclosure is to provide a wireless barcode scanning apparatus to solve problems of limited use scope, inconvenient operation and complicated access and use of barcode information.

In order to achieve the above-mentioned objective, the wireless barcode scanning apparatus includes a main body and a wireless barcode scanning circuit. The main body has a power button formed on the main body. The wireless barcode scanning circuit is mounted in the main body and the wireless barcode scanning circuit includes a Bluetooth processing unit, a near field communicating unit, a barcode scanning unit, a battery unit, and a power control unit.

The near field communicating unit is electrically connected to the Bluetooth processing unit, wherein the near field communicating unit and the Bluetooth processing unit generate an induction signal and a Bluetooth signal to externally provide a wireless induction operation and a wireless connection operation, respectively. The barcode scanning unit is electrically connected to the Bluetooth processing unit and acquires barcode information, and the Bluetooth processing unit wirelessly transmits the barcode information. The battery unit provides a DC power. The power control unit is electrically connected to the battery unit and the power button, wherein the power control unit supplies the DC power to the Bluetooth processing unit, the near field communicating unit, and the barcode scanning unit when the power button is activated.

Accordingly, the wireless barcode scanning apparatus may be widely applied to wireless transmission applications since the NFC induction dominates features of automatic and quick induction match and lower power consumption and the Bluetooth (BT) connection dominates features of high-volume data transmission and high-security data transmission.

Another objective of the present disclosure is to provide a wireless barcode scanning system to solve problems of limited use scope, inconvenient operation and complicated access and use of barcode information.

In order to achieve the above-mentioned objective, the wireless barcode scanning system includes a wireless barcode scanning apparatus and an electronic apparatus. The wireless barcode scanning apparatus includes a main body and a wireless barcode scanning circuit. The main body has a power button formed thereon. The wireless barcode scanning circuit is mounted in the main body and the wireless barcode scanning circuit includes a Bluetooth processing unit, a near field communicating unit, a barcode scanning unit, a battery unit, and a power control unit.

The near field communicating unit is electrically connected to the Bluetooth processing unit, wherein the near field communicating unit and the Bluetooth processing unit generate an induction signal and a Bluetooth signal, respectively. The barcode scanning unit is electrically connected to the Bluetooth processing unit and acquires barcode information. The battery unit provides a DC power. The power control unit is electrically connected to the battery unit and the power button, wherein the power control unit supplies the DC power to the Bluetooth processing unit, the near field communicating unit, and the barcode scanning unit when the power button is activated.

The electronic apparatus includes a Bluetooth unit and a storage unit. The Bluetooth unit provides a wireless induction connection with the near field communicating unit via the induction signal and establishes a wireless Bluetooth connection with the Bluetooth processing unit via the Bluetooth signal. The storage unit is electrically connected to the Bluetooth unit. The wireless barcode scanning apparatus transmits the barcode information to the storage unit by the wireless Bluetooth connection.

Accordingly, the wireless barcode scanning system may be widely applied to wireless transmission applications since the NFC induction dominates features of automatic and quick induction match and lower power consumption and the BT connection dominates features of high-volume data transmission and high-security data transmission.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a front perspective view of a wireless barcode scanning apparatus according to the present disclosure;

FIG. 2 is a rear plan view of the wireless barcode scanning apparatus according to the present disclosure;

FIG. 3 is a block circuit diagram of a wireless barcode scanning circuit of the wireless barcode scanning apparatus according to the present disclosure;

FIG. 4 is a schematic view of a wireless barcode scanning system according to the present disclosure;

FIG. 5 is a flowchart of operating the wireless barcode scanning apparatus according to the present disclosure; and

FIG. 6 is a schematic view of using a conventional wired barcode scanner.

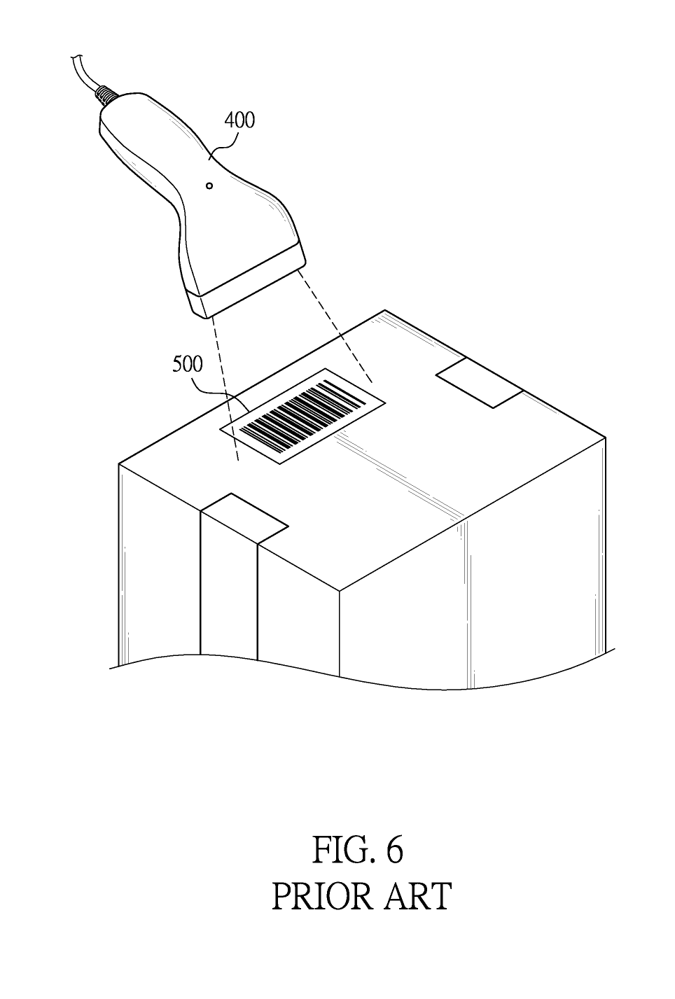

### DETAILED DESCRIPTION

Reference will now be made to the drawing figures to describe the present disclosure in detail.

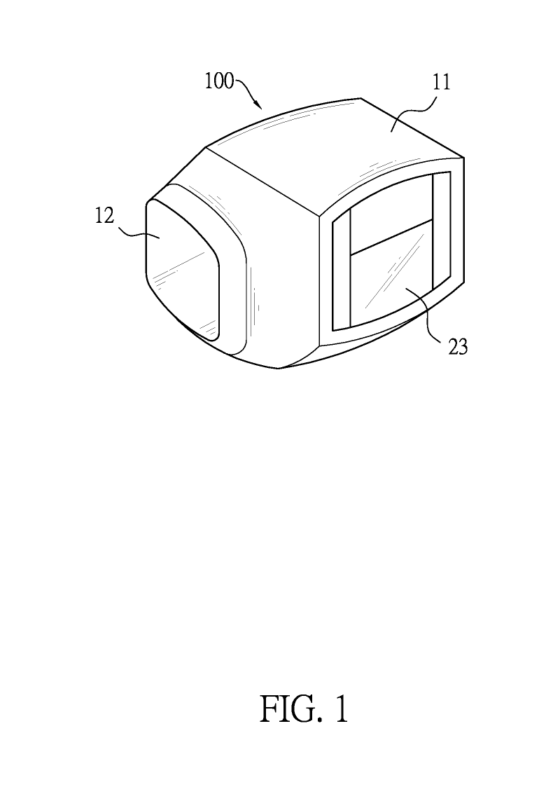

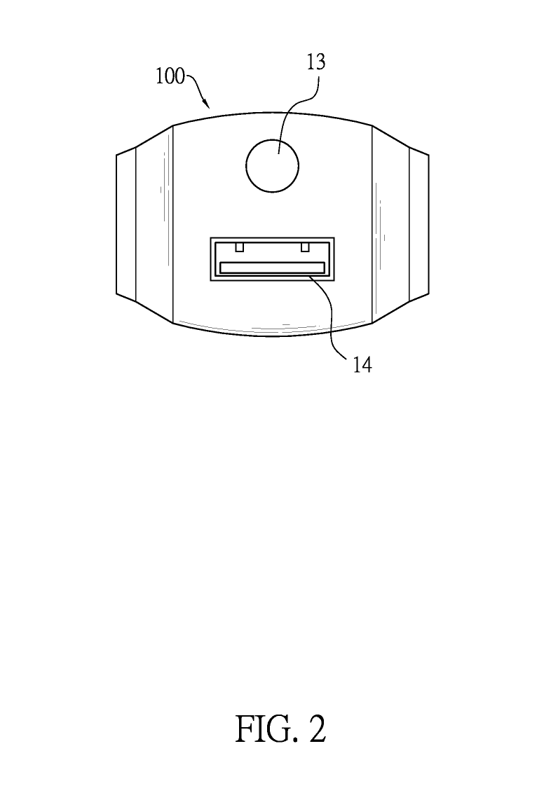

FIG. 1 and FIG. 2 show a front perspective view and a rear plan view of a wireless barcode scanning apparatus according to the present disclosure, respectively. The wireless barcode scanning apparatus 100 is a wearable wireless barcode scanning apparatus. In particular, the wireless barcode scanning apparatus 100 is a ring-type scanner which may be worn on a user's finger. The wireless barcode scanning apparatus 100 includes a main body 11, a wearing channel 12, a barcode scanning unit 23, a power button 13, and a transmitting port 14.

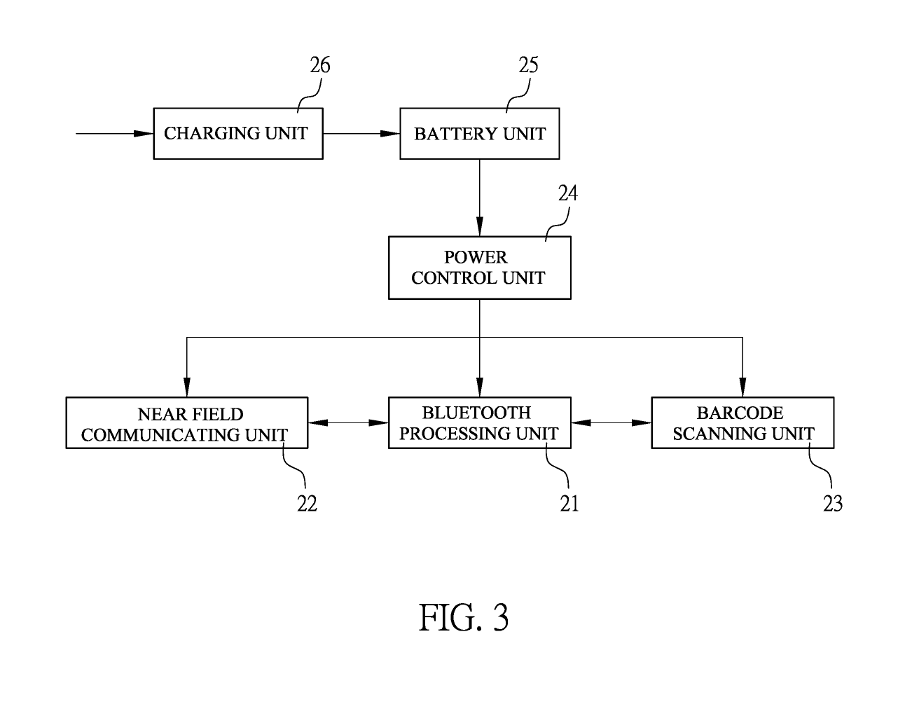

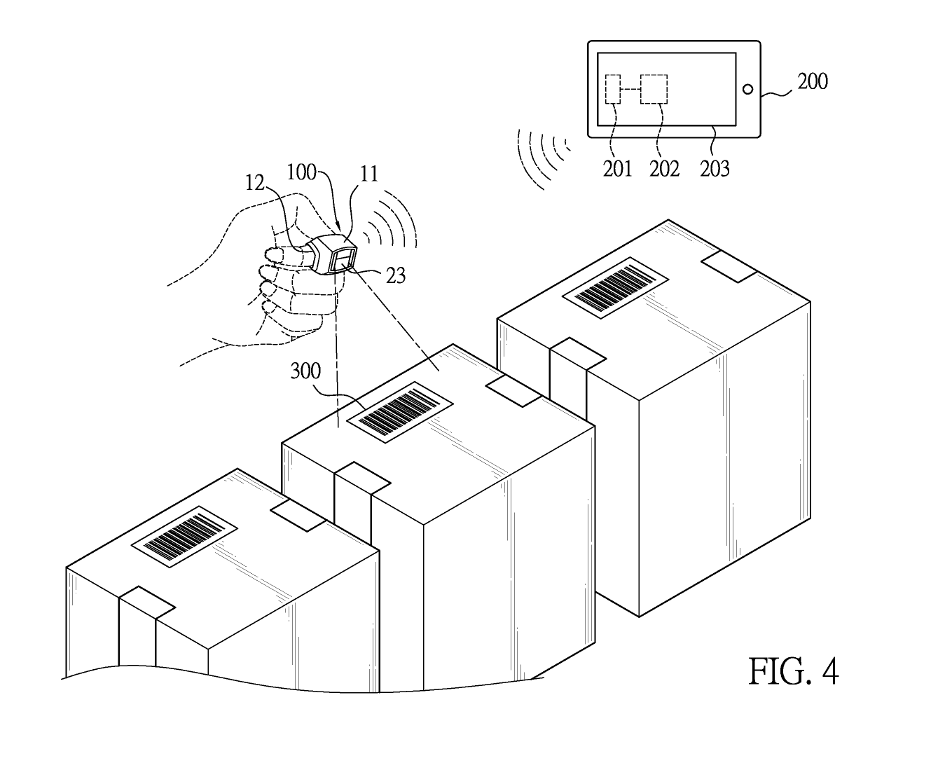

The main body 11 has two side surfaces, a front surface, a back surface, and a containing space for containing circuit components. The detailed operation of the circuit components will be described hereinafter with reference to FIG. 3. In this embodiment, the wearing channel 12 is formed through two opposite surfaces of the main body 11. As shown in FIG. 4, the wireless barcode scanning apparatus 100 is wearable on the user's finger via the wearing channel 12 to execute the barcode-scanning operation.

In this embodiment, the barcode scanning unit 23 is formed on the front surface of the main body 11 as shown in FIG. 1. The barcode scanning unit 23 provides a light source, such as an infrared light source to read barcode information when the wireless barcode scanning apparatus 100 is used for a barcode-scanning operation. The power button 13 is formed on the back surface of the main body 11 as shown in FIG. 2. By long or short pressing the power button 13, the wireless barcode scanning apparatus 100 is powered on, turned off or controlled to quit operation modes.

The transmitting port 14 is also formed on the back surface of the main body 11 as shown in FIG. 2. The transmitting port 14 is, but not limited to, a universal serial bus (USB) interface used to receive an external power source for providing required power to the wireless barcode scanning apparatus 100.

The user wears the wireless barcode scanning apparatus 100 via the wearing channel 12 to execute the barcode-scanning operation. The detailed barcode-scanning operation of the wireless barcode scanning apparatus 100 will be described hereinafter with reference to FIG. 4. The user short presses the power button 13 to start a barcode-scanning operation and the barcode scanning unit 23 provides a scanning light source, such as an infrared light source to read barcode information. Also, the user long presses the power button 13 to turn off the wireless barcode scanning apparatus 100.

FIG. 3 shows a block circuit diagram of a wireless barcode scanning circuit of the wireless barcode scanning apparatus according to the present disclosure. As mentioned above, the circuit components of the wireless barcode scanning apparatus 100 include a Bluetooth processing unit 21, a near field communicating unit 22, the barcode scanning unit 23, a power control unit 24, a battery unit 25, and a charging unit 26. The Bluetooth processing unit 21 is a Bluetooth chip with part number CSR101X. The near field communicating unit 22 is a NFC tag with part number RF430CL330. The barcode scanning unit 23 is a scanner module with part number SE955 or the barcode scanning unit 23 is composed of a scan engine with part number SE4500 and a decoder with part number PL3307. The power control unit 24 is an integrated circuit with part number A7111. The battery unit 25 is a rechargeable battery. The charging unit 26 is an integrated circuit with part number BQ24040.

The near field communicating unit 22 is electrically connected to the Bluetooth processing unit 21, and a bi-directional transmission is achieved between the near field communicating unit 22 and the Bluetooth processing unit 21. The barcode scanning unit 23 is electrically connected to the Bluetooth processing unit 21 to execute the barcode-scanning operation, and a bi-directional transmission is achieved between the barcode scanning unit 23 and the Bluetooth processing unit 21. The Bluetooth processing unit 21 is in communication with the near field communicating unit 22 and the barcode scanning unit 23 in a bi-directional manner, respectively.

The charging unit 26 is electrically connected between the transmitting port 14 and the battery unit 25, and the transmitting port 14 is used to receive the external power source. The charging unit 26 controls the external power source to charge the battery unit 25. For example, the charging unit 26 controls the charging voltage and/or the charging current for charging the battery unit 25 according to charging and discharging characteristics of the battery unit 25 after receiving the external power source. After being charged by the external power source, the battery unit 25 provides a DC power.

One input terminal of the power control unit 24 is electrically connected to the battery unit 25 to receive the DC power. In addition, one output terminal of the power control unit 24 is electrically connected to the Bluetooth processing unit 21, the near field communicating unit 22, and the barcode scanning unit 23 to control supplying the DC power outputted from the battery unit 25 to the Bluetooth processing unit 21, the near field communicating unit 22, and the barcode scanning unit 23. In the present disclosure, the user operates the power button 13, which is electrically connected to the power control unit 24, to turn on or off the power control unit 24.

FIG. 4 shows a schematic view of a wireless barcode scanning system according to the present disclosure. The wireless barcode scanning system includes a wireless barcode scanning apparatus 100 and an electronic apparatus 200. The wireless barcode scanning apparatus 100 of the wireless barcode scanning system is used to read a barcode 300 and acquire barcode information of the barcode 300. In addition, a wireless transmission is established between the wireless barcode scanning apparatus 100 and the electronic apparatus 200 to transmit the barcode information of the barcode 300 from the wireless barcode scanning apparatus 100 to the electronic apparatus 200. The detailed operation of the wireless barcode scanning system is described as follows.

As shown in FIG. 3, the electronic apparatus 200 is, but not limited to, a smart phone or a tablet computer. The electronic apparatus 200 mainly includes a Bluetooth unit 201, a storage unit 202, and a display unit 203.

The Bluetooth unit 201 provides a near field communication (NFC) function to establish a NFC induction to the near field communicating unit 22 and establish a Bluetooth connection with the Bluetooth processing unit 21 of the wireless barcode scanning apparatus 100. The storage unit 202 is electrically connected to the Bluetooth processing unit 21. In particular, the storage unit 202 may be a built-in memory of the electronic apparatus 200. The display unit 203 is electrically connected to the storage unit 202 to display the barcode information stored in the storage unit 202. In particular, the display unit 203 may be a display monitor of the electronic apparatus 200.

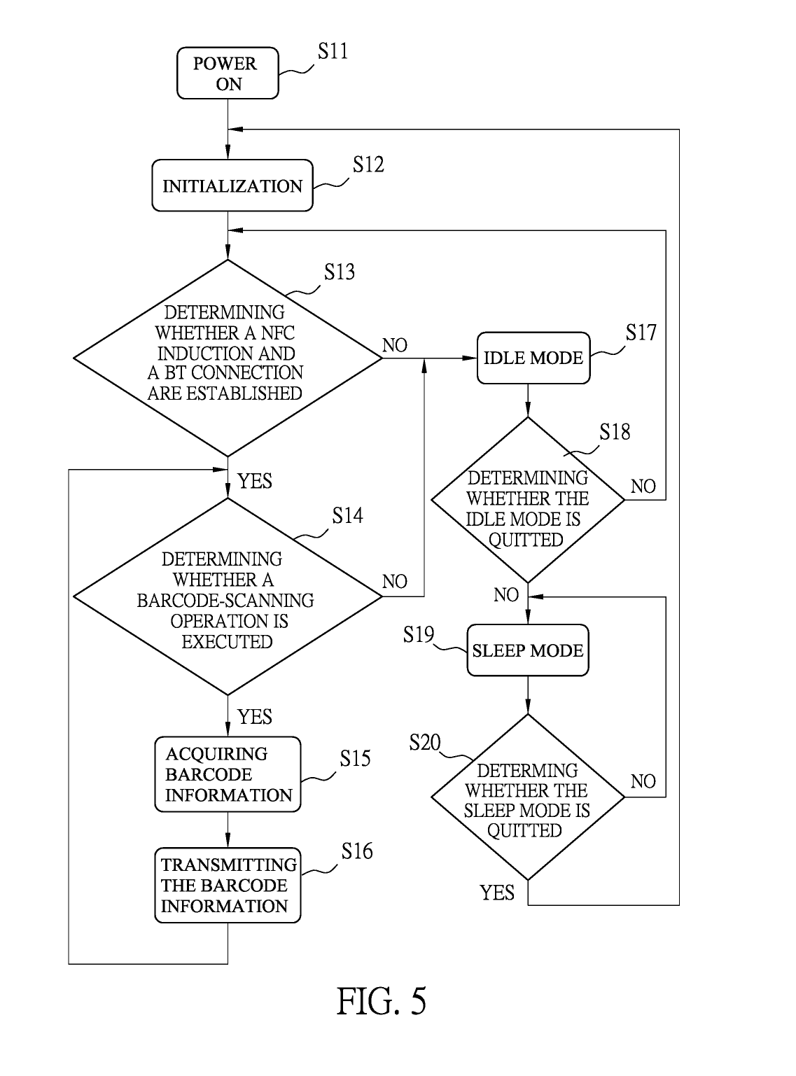

When the NFC induction and the Bluetooth connection between the wireless barcode scanning apparatus 100 and the electronic apparatus 200 are accomplished and the user operates the wireless barcode scanning apparatus 100 to scan the barcode 300, the wireless barcode scanning apparatus 100 acquires the barcode information of the barcode 300 and the barcode information is transmitted to the storage unit 202 to be stored or to the display unit 203 to be displayed by the wireless Bluetooth connection. The detailed operation between the wireless barcode scanning apparatus 100 and the electronic apparatus 200 is described with reference to FIG. 5.

FIG. 5 shows a flowchart of operating the wireless barcode scanning apparatus according to the present disclosure. First, the wireless barcode scanning apparatus 100 is powered on (S11). When the wireless barcode scanning apparatus 100 is turned off, the user long presses the power button 13 for up to five seconds so that the power control unit 24 controls the battery unit 25 to supply the DC power to the Bluetooth processing unit 21, the near field communicating unit 22, and the barcode scanning unit 23 to power on the wireless barcode scanning apparatus 100. Whenever the wireless barcode scanning apparatus 100 is restarted, the related software or firmware in the wireless barcode scanning apparatus 100 is initialized (S12). After being powered on and initialized, the wireless barcode scanning apparatus 100 is in a standby mode.

After the wireless barcode scanning apparatus 100 is in a standby mode, it is to determine whether a near field communication (NFC) induction and a Bluetooth (BT) connection between the wireless barcode scanning apparatus 100 and the electronic apparatus 200 are established (S13). In the step (S13), the user wears the wireless barcode scanning apparatus 100 to directly contact or near communicate with the electronic apparatus 200 so that the near field communicating unit 22, such as a NFC tag, is wirelessly connected to a NFC tag inside the electronic apparatus 200.

After the NFC induction between the wireless barcode scanning apparatus 100 and the electronic apparatus 200 is accomplished, the near field communicating unit 22 is in communication with the Bluetooth processing unit 21 to establish the Bluetooth connection between the wireless barcode scanning apparatus 100 and the electronic apparatus 200. After the NFC induction and the Bluetooth connection are accomplished, it is to determine whether the barcode-scanning operation is executed (S14). The user short presses the power button 13 to start the barcode-scanning operation. The barcode scanning unit 23 provides the light source to read barcode information of the barcode 300 (S15). The barcode information acquired from the wireless barcode scanning apparatus 100 is transmitted to the electronic apparatus 200 via the Bluetooth connection (S16).

After the barcode information is completely transmitted, the wireless barcode scanning apparatus 100 executes the step (S14) to determine whether the barcode-scanning operation is to continue. If the barcode-scanning operation is to continue by the wireless barcode scanning apparatus 100, the step (S15) and the step (S16) are executed. On the contrary, if the user stops executing the barcode-scanning operation, the wireless barcode scanning apparatus 100 enters an idle mode (S17). In the step (S14), it is to determine whether the barcode-scanning operation is not executed by the wireless barcode scanning apparatus 100 when no barcode information is transmitted to the electronic device 200 within a predetermined time. For one example, the wireless barcode scanning apparatus 100 enters the idle mode once no barcode information is transmitted to the electronic apparatus 200 within sixty seconds after the NFC induction and the BT connection are accomplished by the electronic apparatus 200 (S13). For another example, the wireless barcode scanning apparatus 100 enters the idle mode once no barcode information is transmitted to the electronic apparatus 200 within sixty seconds after the barcode information is transmitted to the electronic apparatus 200 (S16).

In addition, the wireless barcode scanning apparatus 100 also enters the idle mode (S17) when the NFC induction or the BT connection is not established (S13) within a predetermined time, including failed NFC induction or failed BT connection. For example, the wireless barcode scanning apparatus 100 enters the idle mode (S17) once the NFC induction or the BT connection is not established within fifty seconds after initializing the wireless barcode scanning apparatus 100.

It is to determine whether the idle mode is quitted (S18) after the step (S17). In one embodiment, the idle mode is quitted and the step (S13) and the subsequent steps are re-executed to resume the operation of the wireless barcode scanning apparatus 100 once the user short presses the power button 13 within sixty seconds after the wireless barcode scanning apparatus 100 enters the idle mode. In another embodiment, the idle mode is quitted and the step (S13) and the subsequent steps are re-executed to resume the operation of the wireless barcode scanning apparatus 100 once the NFC induction is executed by directly contacting the wireless barcode scanning apparatus 100 with the electronic apparatus 200 within sixty seconds after the wireless barcode scanning apparatus 100 enters the idle mode.

On the contrary, the wireless barcode scanning apparatus 100 enters a sleep mode (S19) once the idle mode is not quitted within the predetermined time after the wireless barcode scanning apparatus 100 enters the idle mode. During the sleep mode, the battery unit 25 stops supplying power to circuit elements that consume more power and keeps supplying power to circuit elements that consume less power, integrated circuits (ICs) or essential circuit elements, thus reducing power consumption of the wireless barcode scanning apparatus 100.

It is to determine whether the sleep mode is quitted (S20) after the step (S19). In one embodiment, the sleep mode is quitted and the step (S12) and the subsequent steps are re-executed to wake the operation of the wireless barcode scanning apparatus 100 once the user long presses the power button 13 for up to five seconds after the wireless barcode scanning apparatus 100 enters the sleep mode. On the contrary, the wireless barcode scanning apparatus 100 is still in the sleep mode (S19) if the sleep mode is not quitted. In particular, the length of time mentioned in the steps (S13), (S14), (S18) and (S20) is not limited in the examples. Also, the length of time may be reasonably set according to the use occasion of the wireless barcode scanning apparatus 100 and the operation request of the user.

In conclusion, the present disclosure has the following advantages:

1. The NFC induction and the BT connection that are integrated may be widely applied to wireless transmission applications since the NFC induction dominates features of automatic and quick induction match and lower power consumption and the BT connection dominates features of high-volume data transmission and high-security data transmission;

2. The small-size and light-weight wireless barcode scanning apparatus 100 is wearable on a finger to be easy to carry and to significantly increase convenience and flexibility of using the wireless barcode scanning apparatus 100;

3. The USB interface is used to easily acquire the external power source for providing required power to the wireless barcode scanning apparatus 100; and

4. The wireless barcode scanning apparatus 100 reduces power consumption when entering the sleep mode.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

1. A wireless barcode scanning apparatus, comprising:
a main body having a power button formed on the main body; and
a wireless barcode scanning circuit mounted in the main body, the wireless barcode scanning circuit comprising:
a short-range communication protocol processing unit; wherein the short-range communication protocol is implementing IEEE standard 802.15.1;
a near field communicating unit electrically connected to the short-range communication protocol processing unit, wherein the near field communicating unit is configured to generate an induction signal and the short-range communication protocol processing unit is configured to generate a short-range communication protocol signal; the near field communicating unit externally provides a wireless induction match operation via the induction signal and then the short-range communication protocol processing unit externally provides a wireless connection operation via the short-range communication protocol signal;
a barcode scanning unit electrically connected to the short-range communication protocol processing unit and configured to acquire barcode information, and the short-range communication protocol processing unit configured to wirelessly transmit the barcode information;
a battery unit configured to provide a DC power; and
a power control unit electrically connected to the battery unit and the power button, wherein the power control unit is configured to supply the DC power to the short-range communication protocol processing unit, the near field communicating unit, and the barcode scanning unit when the power button is activated.

2. The wireless barcode scanning apparatus as claimed in claim 1, further comprising:
a wearing channel formed through two opposite surfaces of the main body.

3. The wireless barcode scanning apparatus as claimed in claim 1, further comprising:
a transmitting port formed on the main body and configured to receive an external power source; and
a charging unit electrically connected to the transmitting port and the battery unit and configured to receive the external power source and control the battery unit.

4. The wireless barcode scanning apparatus as claimed in claim 2, further comprising:
a transmitting port formed on the main body and configured to receive an external power source; and
a charging unit electrically connected to the transmitting port and the battery unit and configured to receive the external power source and control the battery unit.

5. The wireless barcode scanning apparatus as claimed in claim 3, wherein the transmitting port is a universal serial bus (USB) port.

6. The wireless barcode scanning apparatus as claimed in claim 4, wherein the transmitting port is a universal serial bus (USB) port.

7. A wireless barcode scanning system, comprising:
a wireless barcode scanning apparatus, comprising:
a main body having a power button formed thereon; and
a wireless barcode scanning circuit mounted in the main body, the wireless barcode scanning circuit comprising:
a short-range communication protocol processing unit; wherein the short-range communication protocol is implementing IEEE standard 802.15.1;
a near field communicating unit electrically connected to the short-range communication protocol processing unit, wherein the near field communicating unit is configured to generate an induction signal and the short-range communication protocol processing unit is configured to generate a short-range communication protocol signal;
a barcode scanning unit electrically connected to the short-range communication protocol processing unit and configured to acquire barcode information;
a battery unit configured to provide a DC power; and
a power control unit electrically connected to the battery unit and the power button, wherein the power control unit is configured to supply the DC power to the short-range communication protocol processing unit, the near field communicating unit, and the barcode scanning unit when the power button is activated; and
an electronic apparatus, comprising:
a short-range communication protocol unit configured to provide a near field communication function, wherein the short-range communication protocol unit is configured to provide a wireless induction match connection with the near field communicating unit via the induction signal and then establish a wireless short-range communication protocol connection with the short-range communication protocol processing unit via the short-range communication protocol signal; and
a storage unit electrically connected to the short-range communication protocol unit;
wherein the wireless barcode scanning apparatus is configured to transmit the barcode information to the storage unit by the wireless short-range communication protocol connection.

8. The wireless barcode scanning system as claimed in claim 7, wherein the wireless barcode scanning apparatus further comprises:
a wearing channel formed through two opposite surfaces of the main body.

9. The wireless barcode scanning system as claimed in claim 7, further comprising:
a transmitting port formed on the main body and configured to receive an external power source; and
a charging unit electrically connected to the transmitting port and the battery unit and configured to receive the external power source and control the battery unit.

10. The wireless barcode scanning system as claimed in claim 8, further comprising:
a transmitting port formed on the main body and configured to receive an external power source; and
a charging unit electrically connected to the transmitting port and the battery unit and configured to receive the external power source and control the battery unit.

11. The wireless barcode scanning system as claimed in claim 9, wherein the transmitting port is a universal serial bus (USB) port.

12. The wireless barcode scanning system as claimed in claim 10, wherein the transmitting port is a universal serial bus (USB) port.

13. The wireless barcode scanning system as claimed in claim 7, wherein the electronic apparatus further comprises:
a display unit electrically connected to the storage unit to display the barcode information stored in the storage unit.
